(19) United States
(12) Patent Application Publication
(10) Pub. No.: US 2008/0127038 A1
(43) Pub. Date: May 29, 2008

(54) APPARATUS AND METHOD FOR DETECTING SELF-EXECUTABLE COMPRESSED FILE

(75) Inventors: Jae Woo Park, Taejon (KR); Young Tae Yun, Taejon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Taejon (KR)

(21) Appl. No.: 11/860,599

(22) Filed: Sep. 25, 2007

(30) Foreign Application Priority Data
Nov. 23, 2006 (KR) 2006-0116573
Jul. 20, 2007 (KR) 2007-0072912

(51) Int. Cl. G06F 9/44

(52) U.S. Cl. 717/100

(57) ABSTRACT

Provided are an apparatus and a method for detecting a self-executable compressed file by analyzing an executable program. The present invention firstly performs a static analysis on an executable file to search an executable file format, examines a section name part to determine whether the executable file format can be executable or not in compliance with a PE format standard based on a general PE file structure, and determines the executable file as a suspicious file if there is an abnormal section name or structure. Secondly, instructions are examined through disassembling in a section range where a corresponding executable file entry point exists if the suspicious part is found in the first analysis, and it is determined that the file is finally self-executable compressed if there is a file jumping from an address space of a section range where the entry point exists and jumping into a memory region of another section having read/write/execute characteristics. Accordingly, it can be determined whether variants of executable compression programs, file heads with modification and change, or files with unknown executable compression formats are self-executable compressed or not.

### BACKGROUND OF THE INVENTION

1. Field of the Invention

The present invention relates to an apparatus and a method for detecting a self-executable compressed file, and more particularly, to an apparatus and a method for detecting a self-executable compressed file by analyzing an executable program.

2. Description of the Related Art

Self-executable compression has been used to compress one or more files and reduce their file sizes by using compression and encryption algorithms in relatively well-known zip, rar, etc types, and has been developed for program protection purpose by means of reverse engineering. Recently, malicious code programmers make ill use of the self-executable compression in order to create the variants of malicious codes. The main purpose of the self-executable compression is to compress executable files, different from compressions of data files such as zip, rar, etc. Until now, since there have been various executable compression and encryption programs, malicious code programmers utilize these kinds of programs to create the variants of malicious codes, and also continuously upload and distribute diverse executable compressions and encryption programs and their source files throughout the internet. The most representative executable compressions are UPX, ASPack, FSG, Telock, PEComopact, WWPack32, EZip, Pex, jDPack, DoomPack, Mew, etc., and the most representative encryption programs are PE-Crypt, Yoda, PESpin, PE-Encrypter, VGCypt, etc. These programs are distributed without any restriction through the internet, such that general users can easily access and utilize them. Furthermore, thousands of executable compression programs already exist throughout the internet and also are continuously programmed and distributed all over the world every day. A conventional method for detecting whether executable files are self-executable compressed or not collects a predetermined portion of a head part from an executable compression file, and detects whether the executable files are self-executable compressed or not through a pattern matching method. The conventional method generally utilizes a PEID program. However, the PEID program does not correctly work while detecting whether executable files are self-executable compressed or not if a portion of a file head is modified or changed.

### SUMMARY OF THE INVENTION

Accordingly, the present invention is directed to an apparatus and a method for detecting a self-executable compressed file, which substantially obviates one or more problems due to limitations and disadvantages of the related art.

It is an object of the present invention to provide an apparatus and a method for detecting a self-executable compressed file by analyzing an executable program.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus detecting whether an executable program is self-executable compressed or not according to an instruction provided from a key input part, the apparatus including: an abnormal Portable Executable (PE) file format detection module detecting whether a target file is executable in an executable file format, and examining a PE file section name and characteristics of a corresponding executable file; an abnormal instruction analysis module analyzes an instruction on a section having an entry point of a suspicious executable file according to the analysis result of the abnormal PE file format detection module, in order to detect whether there is an instruction jumping into a memory region of another section; and an executable compression determination module determining that the target file is self-executable compressed if there is an instruction jumping into a memory region of another section according to the analysis result of the abnormal instruction analysis module.

The target file may be provided from an external storage according to an instruction of the key input part.

The executable file format may include an MZ header and a PE header.

Analysis target file may be an executable file having an executable file format in the input file.

The executable file format may include an MZ header and a PE header.

The suspicious executable file may be an executable file having an abnormal section name of a PE file of an executable file in the target file.

The suspicious executable file may be an executable file having at least two sections capable of read/write/execute in the target file.

The instruction analysis may be performed on a section having the entry point through disassembling.

The memory region of another section may include read/write/execute properties.

In another aspect of the present invention, there is provided a method for detecting whether an executable program is self-executable compressed or not according to an instruction provided from a key input part, the method including: detecting whether a target file is executable in an executable file format, and examining a PE file section name and characteristics of a corresponding executable file; analyzing an instruction on a section having an entry point of a suspicious executable file according to the analysis result of the abnormal PE file format detection module, in order to detect whether there is an instruction jumping into a memory region of another section; and determining that the target file is self-executable compressed if there is an instruction jumping into a memory region of another section according to the analysis result of the abnormal instruction analysis module.

The executable file format may include an MZ header and a PE header.

The suspicious executable file may be an executable file having an executable file format in the target file.

The executable file format may include an MZ header and a PE header.

The suspicious executable file may be an executable file having an abnormal section name of the target PE file.

The suspicious executable file may be an executable file having at least two sections capable of read/write/execute characteristics in the target file.

The analysis of the instruction may be performed on a section having the entry point through reverse assembling.

The memory region of another section may include read/write/execute characteristics.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 illustrates a block diagram of an apparatus for detecting whether an executable program is self-executable compressed or not according to an embodiment of the present invention; and

FIG. 2 illustrates a flowchart of a method for detecting whether an executable program is self-executable compressed or not according to an embodiment of the present invention.

### DETAILED DESCRIPTION OF THE INVENTION

Reference will now be made in detail to the preferred embodiments of the present invention, examples of which are illustrated in the accompanying drawings.

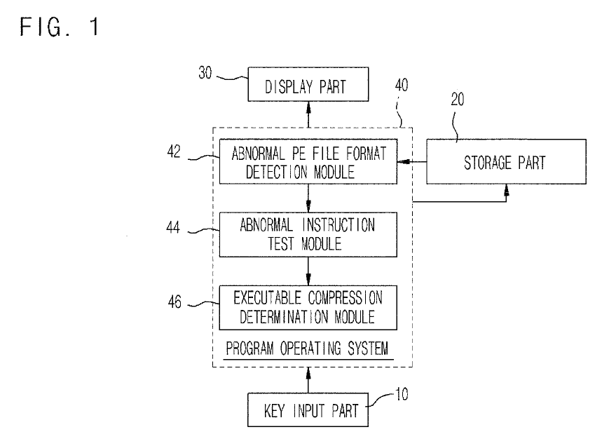

FIG. 1 illustrates a block diagram of an apparatus for detecting whether an executable program is self-executable compressed or not according to an embodiment of the present invention. The apparatus includes a key input part 10, a storage part 20, a display part 30, and a program operating system 40.

Referring to FIG. 1, the key input part 10 may include a keyboard, a mouse, etc., which are utilized by a user in order to provide an instruction to the program operating system 40, such that it can be determined whether a corresponding executable program is self-executable compressed or not.

The program operating system 40 reads a target file from the storage part 20, and the target file corresponds to the executable compression detecting instruction provided from the key input part 10. The program operating system 40 performs the executable compression on the target file read from the storage part 20. The program operating system 40 displays its each operation state and the result of each operation in the display part 30, such that a user can observe each operation state and the result of each operation in the program operating system 40. The storage part 20 includes CD-ROM drive, HDD, etc.

A case where the program operating system 40 detects whether a corresponding executable program is self-executable compressed or not will be described in detail as follows.

An abnormal PE file format detection module 42 in the program operating system 40 detects whether the target file provided from the storage part 20 through a user command is executable in an executable file format such as an MZ header and a PE header, and examines a PE file section name and characteristics of a corresponding executable file. The program operating system 40 starts a program through a user command from the input part 10 in order to detect whether an executable program is self-executable compressed or not.

An abnormal instruction analysis module 44 examines an instruction through disassembling with respect to a section having an entry point of a suspicious executable file according to the analysis result of the abnormal PE file format detection module 42, and detects whether there is an instruction jumping into a memory region of another section having read/write/execute properties. The suspicious executable file is a corresponding executable file in a case where the target file with an executable file format such as an MA header and a PE header is executable, there is an abnormal section name of a PE file in a corresponding executable file, or there are at least two sections capable of read/write/execute according to the analysis result of the abnormal PE file format detection module 42.

An executable compression determination module 46 determines that the target file is self-executable compressed if there is an instruction jumping into a memory region of another section having read/write/execute properties according to the analysis result of the abnormal instruction analysis module 44.

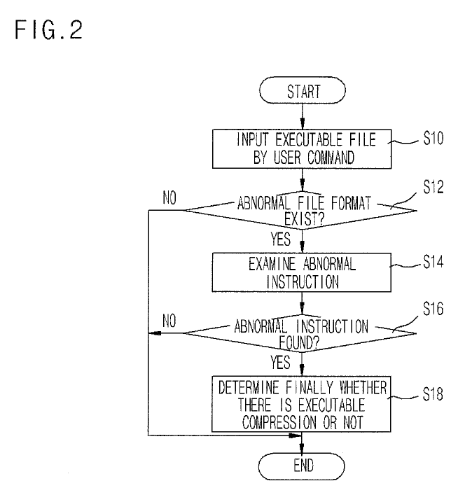

FIG. 2 illustrates a flowchart of a method for detecting whether an executable program is self-executable compressed or not according to an embodiment of the present invention.

In operation S10, the program operating system 40 reads a target file from the storage part 20, and the target file corresponds to the executable compression detecting instruction provided from the key input part 10. The program operating system 40 performs the executable compression on the target file read from the storage part 20. The program operating system 40 displays its each operation state and the result of each operation in the display part 30, such that a user can observe each operation state and the result of each operation in the program operating system 40.

In operations S12 and S14, an abnormal instruction analysis module 44 examines an instruction through disassembling with respect to a section having an entry point of a suspicious executable file according to the analysis result of the abnormal PE file format detection module 42, and detects whether there is an instruction jumping into a memory region of another section having read/write/execute properties. The suspicious executable file is a corresponding executable file in a case where the target file with an executable file format such as an MA header and a PE header is executable, there is an abnormal section name of a PE file in a corresponding executable file, or there are at least two sections capable of read/write/execute according to the analysis result of the abnormal PE file format detection module 42.

In operations S16 and S18, an executable compression determination module 46 determines that the target file is self-executable compressed if there is an instruction jump into a memory region of another section having read/write/execute properties according to the analysis result of the abnormal instruction analysis module 44.

The present invention primarily performs a static analysis on an executable file to search an executable file format, examines a section name part to determine whether the executable file format can be executable or not in compliance with a PE format standard based on a general PE file structure, and determines the executable file as a suspicious file if there is an abnormal section name or a structure, characteristics. Here, PE represents Portable Executable and is a basic file format of Win32. The PE format is diverged from a common object file format (Coff). A portable executable program means that it is portable across Win32 platforms. All Win32 executable files (except for VxD and 16 bit DLL) use the PE file format, and the kernel of NT is loaded into a computer by using the PE file format. Additionally, PE section means code data. According to the PE format standard, each section has its original identification name, and has TEXT, DATA, RDTA, EDATA, IDATA, etc. after a normal compiling process. Also, a user can name an arbitrary section. During the primary process, it can be determined whether there are at least two executable code sections or not, and whether there are at least two PE files in one executable file or not.

Secondly, instructions are examined through disassembling in a section range where a corresponding executable file entry point exists if the suspicious part is found in the primary analysis, and it is determined that the file is finally self-executable compressed if there is a file jumping from an address space of the section range where the entry point exists and jumps into a memory region of another section having read/write/execute properties. In most of the executable compression, an original file is made into data through compression and encryption processes for storing them in another section. Then, the self-executable compressed and encrypted data are self-executable compressed and decrypted when a self-executable compressed program is actually executed, and the execution control and flow of the program return to the original entry point according to its unique properties.

The program operating system 40 may be regarded as one example of an apparatus for detecting a self-executable compressed file of an executable program.

The method of the present invention can be written as computer programs and can be stored in computer readable recording medium (CD-ROM, RAM, ROM, Floppy Disk, Optical Disk, etc.).

The present invention firstly performs a static analysis on an executable file to search an executable file format, examines a section name part to determine whether the executable file format can be executable or not in compliance with a PE format standard based on a general PE file structure, characteristics and determines the executable file as a suspicious file if there is an abnormal section name or structure, characteristics.

Secondly, instructions are examined through disassembling in a section range where a corresponding executable file entry point exists if the suspicious part is found in the first analysis, and it is determined that the file is finally self-executable compressed if there is a file jumping from an address space of a section range where the entry point exists and jumping into a memory region of another section having read/write/execute characteristics. In most of the self-executable compressed file, an original file is made into data through compression and encryption processes for storing them in another section.

Accordingly, it can be determined whether variants of self-executable compression, file heads with modification and change, or files with unknown executable compression formats are self-executable compressed or not.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus detecting whether an executable program is self-executable compressed or not according to an instruction provided from a key input part, the apparatus comprising:
An abnormal Portable Executable (PE) file format detection module detecting whether a target file is executable in an executable file format, and examining a PE file section name and characteristics of a corresponding executable file;
an abnormal instruction analysis module analyzing an instruction on a section having an entry point of a suspicious executable file according to the analysis result of the abnormal PE file format detection module, in order to detect whether there an instruction jumping into a memory region of another section; and
an executable compression determination module determining that the target file is self-executable compressed if there is an instruction jumping into a memory region of another section according to the analysis result of the abnormal instruction analysis module.

2. The apparatus of claim 1, wherein the target file is provided from an external storage according to an instruction of the key input part.

3. The apparatus of claim 1, wherein the executable file format comprises an MZ header and a PE header.

4. The apparatus of claim 1, wherein the suspicious executable file is an executable file having an executable file format in the target file.

5. The apparatus of claim 4, wherein the executable file format comprises an MZ header and a PE header.

6. The apparatus of claim 1, wherein the suspicious executable file is an executable file having an abnormal section name of a PE file of an executable file in the target file.

7. The apparatus of claim 1, wherein the suspicious executable file is an executable file having at least two sections capable of read/write/execute characteristics in the target file.

8. The apparatus of claim 1, wherein the instruction analysis is performed on a section having the entry point through disassembling.

9. The apparatus of claim 1, wherein the memory region of another section comprises read/write/execute characteristics.

10. A method for detecting whether an executable program is self-executable compressed or not according to an instruction provided from a key input part, the method comprising:
detecting whether a target file is executable in an executable file format, and examining a PE file section name and characteristics of a corresponding executable file;
analyzing an instruction on a section having an entry point of a suspicious executable file according to the analysis result of the abnormal PE file format detection module, in order to detect whether there is an instruction jumping into a memory region of another section; and
determining that the target file is self-executable compressed if there is an instruction jumping into a memory region of another section according to the analysis result of the abnormal instruction analysis module.

11. The apparatus of claim 10, wherein the executable file format comprises an MZ header and a PE header.

12. The apparatus of claim 10, wherein the suspicious executable file is an executable file having an executable file format in the target file.

13. The apparatus of claim 12, wherein the executable file format comprises an MZ header and a PE header.

14. The apparatus of claim 10, wherein the suspicious executable file is an executable file having an abnormal section name of a PE file of an executable file in the target file.

15. The apparatus of claim 10, wherein the suspicious executable file is an executable file having at least two sections capable of read/write/execute characteristics in the target file.

16. The apparatus of claim 10, wherein the analysis of the instruction is performed on a section having the entry point through disassembling.

17. The apparatus of claim 10, wherein the memory region of another section comprises read/write/execute characteristics.
